(19) United States
(12) Patent Application Publication
(10) Pub. No.: US 2026/0307136 A1
(43) Pub. Date: Oct. 8, 2026

(54) TWO-FIRE FORMING FORGING PROCESS FOR LARGE CRANK THROW

(71) Applicant: ZHONGJUXIN OCEAN ENGINEERING EQUIPMENT CO., LTD., Yancheng, Jiangsu (CN)

(72) Inventors: HUI ZHANG, Yancheng, Jiangsu (CN); LIANHUA ZHANG, Yancheng, Jiangsu (CN); XIZHONG CHEN, Yancheng, Jiangsu (CN)

(73) Assignee: ZHONGJUXIN OCEAN ENGINEERING EQUIPMENT CO., LTD., Yancheng, Jiangsu (CN)

(21) Appl. No.: 19/160,115

(22) PCT Filed: Aug. 2, 2022
(86) PCT No.: PCT/CN2022/109747

§ 371 Date: Aug. 27, 2025

(30) Foreign Application Priority Data
Jan. 20, 2022 (CN) 202210065615.7
Jan. 20, 2022 (CN) 202210065671.0
Jan. 20, 2022 (CN) 202210066077.3
Jan. 20, 2022 (CN) 202210066376.7

(51) Int. Cl. B21J 1/06; B21J 5/02

(52) U.S. Cl. CPC B21J 1/06; B21J 5/025

(57) ABSTRACT

A two-heating forming forging process for a large crank throw, involving a forging machine, anvil dies, and an operating equipment, and including: setting a shape and parameters of a prefabricated forged part with a boss and double wings in a first heating, and performing multiple upsetting and drawing processes to complete forging of the prefabricated part; setting a shape and parameters of a multi-step transition part in a second heating, performing forging by changing angles, flipping back and forth and moving laterally, repeatedly replacing the anvil dies, performing rolling squeezing and bending by adopting a reverse-fastening bending die with an arc-shaped squeezing surface, and performing multiple press-fittings by adopting multiple core dies to achieve the progressive transition forming of the forged part and complete the forming forging of the crank throw.

### CROSS-REFERENCE TO RELATED APPLICATIONS

The present disclosure claims priority to Chinese Patent Application No. 202210066376.7, filed with the China National Intellectual Property Administration on Jan. 20, 2022 and entitled “TWO-HEATING FORMING FORGING PROCESS FOR LARGE CRANK THROW”, Chinese Patent Application No. 202210065615.7, filed with the China National Intellectual Property Administration on Jan. 20, 2022 and entitled “FORGING PROCESS FOR CRANK THROW PREFABRICATED PART”, Chinese Patent Application No. 202210065671.0, filed with the China National Intellectual Property Administration on Jan. 20, 2022 and entitled “LARGE CRANK THROW JOURNAL FORGING PROCESS”, and Chinese Patent Application No. 202210066077.3, filed with the China National Intellectual Property Administration on Jan. 20, 2022 and entitled “CRANK THROW FORMING FORGING PROCESS”, which are incorporated herein by reference in their entireties.

### TECHNICAL FIELD

The present disclosure relates to a crank throw forged part, and in particular, to a two-heating forming forging process for a large crank throw, belonging to the technical field of forging. Specifically, the present disclosure relates to a prefabricated part of a combined crank throw forged part, and in particular, to a forging process for a large combined crank throw prefabricated part. In addition, the present disclosure further relates to forging of a large crank throw, and in particular, to a forging process for a large crank throw journal. Besides, the present disclosure further relates to a crank throw forming forging process.

### BACKGROUND

A crankshaft is a primary component for conversion between mechanical rotary motion and reciprocating motion. A crank throw is a critical part of the crankshaft. As the crankshaft undertakes the conversion between mechanical rotary motion and reciprocating motion, crank throws of large crankshafts endure substantial and complex stresses. Consequently, they must possess sufficient rigidity, strength, and capacity to withstand impact loads. To meet the above performance requirements, forged products are typically selected for crank throws of large combined crankshafts. The production process for forged crank throws is complex, requiring multiple operations, multiple heatings, and repeated replacement of anvil dies to complete the process. A throw journal is a section connecting the crank throw to a connecting rod. Its forging process is the most intricate. At one end of double wings of the crank throw, a cylindrical forging billet approximating the journal shape of the throw journal is formed through integral forging.

Common forging methods include solid forging, die forging, and bend forging. Among these, die forging requires forging machines with pressure of tens of thousands of tons and expensive dies, yet quality of forged parts remains unsatisfactory. Bend forging offers good metal flow, favorable forming, operational convenience, and lower equipment demands. However, it necessitates more heatings, resulting in significant material and energy consumption. Even the most advanced domestic and international manufacturers need 5 to 7 heatings to complete the forging, and the cold machining allowance of forged parts remains large. Traditional methods for forging crank throws include die forging and free forging. Due to inherent drawbacks, these methods not only incur high production costs and low efficiency but also require forging machines with pressure of tens of thousands of tons or more and costly dies. Additionally, the yield rate of forged parts is low, and the forging ratio cannot be satisfied, resulting in coarse grains and substandard internal micro-structure quality. Further, forging defects and folds frequently occur.

The applicant conducted simulation calculations and scientific analysis on the above problems. The traditional crank throw forging process exhibits the following defects: primarily, outdated forging technology; secondly, unreasonable die arrangement; and thirdly, unscientific anvil die replacement methods. Therefore, it is necessary to scientifically redesign and improve the forging process.

### SUMMARY

The present disclosure provides a two-heating forming forging process for a large crank throw, including setting a shape and parameters of a double-winged body with a boss in a first heating, setting transition shapes, parameters and bending parameters of double wings and a throw journal to be forged in a second heating, and performing a semi-die forging process, thus achieving a purpose of forging a large crank throw forged part through two heatings.

Specifically, the present disclosure provides a forging process for a crank throw prefabricated part, including setting a shape and parameters of the crank throw prefabricated part, setting automatically replaced anvil dies, and performing repeated upsetting and drawing forging processes, thus achieving forging in one heating. The present disclosure provides a forging process for a large crank throw journal, adopting multiple different special anvil dies to perform multi-frequency and multi-angle repeated forging on a forged part by changing anvil dies for multiple times to achieve progressive forming of a throw journal, thus achieving the smallest cold machining allowance of the throw journal and the fastest forging process. The present disclosure provides a crank throw forming forging process, including setting a shape and parameters of a process forged part, and completing throw journal forming, process shaping, bending, press-fitting, and finishing in one heating, thus achieving purposes of decreasing heatings and increasing the forging ratio.

The present disclosure provides the following technical solution: a two-heating forming forging process for a large crank throw, involving a forging machine, a plurality of anvil dies, and an operating equipment, the anvil dies including an upper anvil, a lower die, core dies, and an upper die, the lower die including a small flat anvil, a large flat anvil, a double-ridged groove die, a convex die, a trapezoidal die, and a concave die, the upper die including an upsetting plate, a replaceable anvil die, and a reverse-fastening bending die; the operating equipment including a worktable and a manipulator, the worktable including a transverse worktable and a longitudinal worktable, the manipulator including a first manipulator and a second manipulator; the upper anvil being connected to the forging machine, the convex die and the double-ridged groove die respectively forming a fixed hinge with the large flat anvil, the replaceable anvil die including a concave replaceable anvil die and an arc-shaped replaceable anvil die, multiple core dies being provided, thickness differences between two ends of different core dies being different, the lower die being placed on the transverse worktable and moving with the transverse worktable, the first manipulator clamping a forged part, the second manipulator clamping the core dies or the upper die, where the two-heating forming forging process for a large crank throw may include the following steps:
a first heating: forging a prefabricated part of a double-winged body with a boss in a middle part setting the double-winged body to have a length of L, a width of b, and a height of h1; and setting the boss to have a height of h2 and a width of b, then the total height of the prefabricated part being h=h1+h2,
step 1: selecting a steel billet according to a weight requirement of the crank throw forged part, and heating the steel billet to a set forging temperature;
step 2: placing the steel billet heated in step I between the upper anvil and the small flat anvil, and drawing out the steel billet;
step 3: standing a length direction of the forged part drawn out in step 2 on the longitudinal worktable, clamping and placing the upsetting plate between the forged part and the upper anvil through the second manipulator, and upsetting the forged part to ½ of an original length;
step 4: drawing out the forged part upset in step 3 to obtain a forged part with a cross section of (3b/4)×(3b/4);
step 5: standing a length direction of the forged part drawn out in step 4 on the longitudinal worktable, and upsetting the forged part to ½ of the original length;
step 6: drawing out the forged part upset in step 5 to obtain a forged part with a cross section of b×b;
step 7: placing a middle part of the forged part obtained in step 6 above the double-ridged groove die, and forging parallel left and right grooves below the forged part; and
step 8: vertically flipping the forged part with the left and right grooves obtained in step 7 180°, placing the forged part on the large flat anvil for forging, correspondingly forging a left side of the left groove and a right side of the right groove into a double-winged body with a width of b, a height of h1, and a length of L, and forging a part between the left and right grooves into a boss with a height of h2 and a width of b to obtain the prefabricated part of the double-winged body; and
a second heating: forging forming
setting transition shapes and parameters of double wings and a throw journal, and setting bending parameters,

### I. Throw Journal Forging

step 9: heating the forged part obtained in step 8 to a forging temperature;
step 10: placing the heated prefabricated part on the large flat anvil, thinning and drawing out the double wings, and performing finishing to a set size of a process forged part;
step 11: clamping the prefabricated part through the first manipulator, placing a middle part of the prefabricated part obtained in step 10 above the convex die, and performing forging by flipping 180° back and forth, moving laterally and changing positions for multiple times to preliminarily forge two side surfaces of the throw journal;
step 12: placing the boss of the prefabricated part obtained in step 11 upwards on the trapezoidal die, clamping and sleeving the concave anvil replaceable anvil die on the prefabricated part through the second manipulator, and forging a bottom surface of the double-winged body opposite to the boss to preliminarily forge a lower surface of the throw journal;
step 13: placing the two side surfaces and the lower surface of the throw journal obtained in step 11 and step 12 on the convex die, and alternately forging the two side surfaces, the lower surface, and a connecting position of the throw journal by flipping back and forth and moving laterally until a shape is close to the shape of the throw journal;
step 14: placing the throw journal of the prefabricated part obtained in step 13 on the concave die, changing forging angles by flipping back and forth, and downwards pressing a head of the boss through the upper anvil, so that the head of the boss is forged into a polygonal upper surface of the throw journal, and the two side surfaces and the lower surface of the throw journal are forged into a semi-cylindrical body;
step 15: placing the throw journal forged in step 14 alternately on the convex die and the concave die, and forging the throw journal at multiple angles through the upper anvil by respectively adopting a non-flat anvil and the arc-shaped replaceable anvil die to obtain a cylindrical billet of the throw journal;

### II. Bending

step 16: placing a lower surface of the cylindrical throw journal on the concave die, clamping and reversely fastening the reverse-fastening bending die onto the upper surface of the double wings of the double-winged body through the second manipulator, and enabling the upper anvil to press downwards, so that the prefabricated part is bent to a set angle to form a V-shape;

### III. Press-Fitting

step 17: placing the V-shaped prefabricated part on the large flat anvil, inserting the core dies with the largest thickness difference between two ends into an opening of the prefabricated part through the second manipulator, enabling the upper anvil to press downwards, press-fitting two sides of the V-shape so that the two sides of the prefabricated part get close to each other, and performing forging again by flipping vertically so that the two sides of the prefabricated part get close to the core dies;
step 18: sequentially replacing the core dies with gradually decreasing thickness differences between two ends, repeating step 17 so that the double wings of the double-winged body are in contact with the core dies, flipping the prefabricated part for forging, and finishing an outer side of the double-winged body to obtain a crank of the crank throw;

### IV. Head Drawing

step 19: synchronously flipping the core dies and the prefabricated part in a press-fit state, placing them on the large flat anvil, forging the head of the boss, and drawing the head into a quadrangular-frustum-pyramid crank throw head; and

### V. Finishing

step 20: placing the prefabricated part obtained in step 19 on the large flat anvil or the small flat anvil, and finishing the crank throw to a set size of a finished forged part.

Preferably, the first manipulator may a left manipulator and the second manipulator may a right manipulator.

Preferably, in step 2, the steel billet may be drawn out to 1.2 to 1.7 times the original length.

Preferably, in step 3, the rectangular forged part may be upset to ½±20% of the original length.

Preferably, in step 4, the forged part may be drawn out to obtain a rectangular billet with a cross section of 3b/4 (1±5%)×3b/4 (1±5%).

Preferably, in step 5, the forged part may be upset to ½±10% of the original length.

Preferably, in step 6, the forged part may be upset to obtain a forged part with a cross section of b(1+0-5%)×b(1+0-5%).

Preferably, the convex die may be an arc-shaped die.

Preferably, the diameter of the prefabricated part of the throw journal in a vertical direction may be equal to the diameter of a finished product ±5%.

Preferably, a concave surface of the concave replaceable anvil die may be engaged with a convex surface of the prefabricated part.

In the present disclosure, the shape and parameters of the prefabricated forged part with the boss and double wings in the first heating are set, and multiple upsetting and drawing processes are performed to complete forging of the prefabricated forged part; the shape and parameters of the multi-step transition part in the second heating are set, forging is performed by changing angles, flipping back and forth and moving laterally, the anvil dies are repeatedly replaced, rolling squeezing and bending are performed by adopting the reverse-fastening bending die with the arc-shaped squeezing surface, and press-fitting is performed for multiple times by adopting multiple core dies to achieve the progressive transition forming of the forged part and complete the forming forging of the crank throw.

The forging process for a crank throw prefabricated part in the present disclosure adopts multiple upsetting and drawing processes, thus increasing the forging ratio, improving the internal quality of the forged part, achieving the progressive transition forming of the forged part, completing the forging of the crank throw prefabricated part in one heating, and achieving purposes of the simplest forging steps, the minimum material loss, and the lowest production cost.

The forging process for the large crank throw journal in the present disclosure adopts multiple different special anvil dies to perform forging by changing angles, flipping back and forth, moving laterally and repeatedly replacing different anvil dies, thus making the throw journal formed progressively, and achieving purposes of good throw journal billet formability, small machining allowance, short forging time, low material loss, and low production cost.

The crank throw forming forging process in the present disclosure adopts multiple different special anvil dies to perform forging by moving laterally, flipping back and forth, changing angles and repeatedly replacing different anvil dies, thus making the throw journal formed progressively. By setting the reverse-fastening bending die between the forged part and the upper anvil, not only can the anvil die be rapidly replaced, but also rolling squeezing can be formed between the double-winged body of the forged part and the die during bending through the arc-shaped squeezing surface of the bending die, thus continuously bending the crank throw forged part under small squeezing force and short squeezing travel, completing the bending process of the large crank throw forged part through the forging machine with small pressure, and achieving the forging in one heating.

The present disclosure accomplishes forming forging and bending forging of the crank throw forged part under relatively low pressure and short forging travel, and completes the forging process for the large crank throw forged part through the forging machine with small pressure. This design has the characteristics of high forging ratio, good formability, small machining allowance, short forging time, small material loss, and low production cost.

### BRIEF DESCRIPTION OF THE DRAWINGS

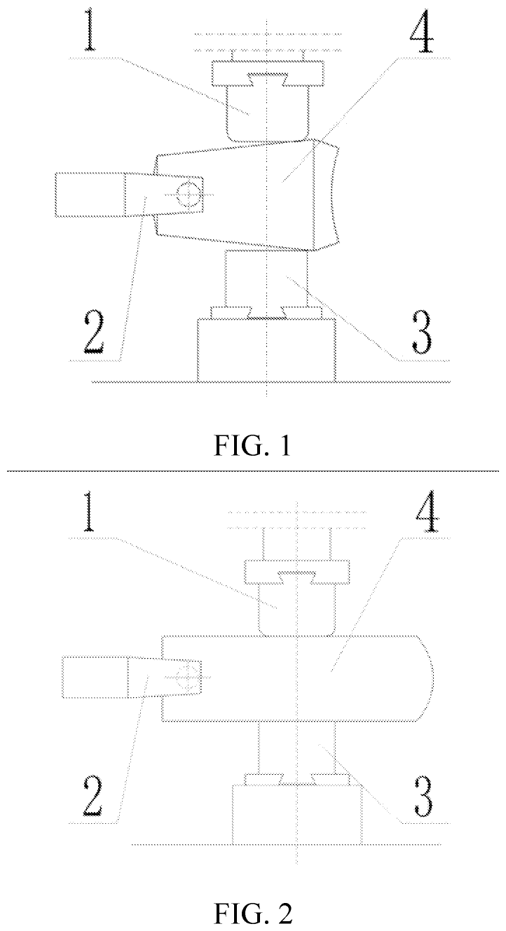

FIG. 1 is a schematic diagram in an initial state in step 2;

FIG. 2 is a schematic diagram in a final state in step 2;

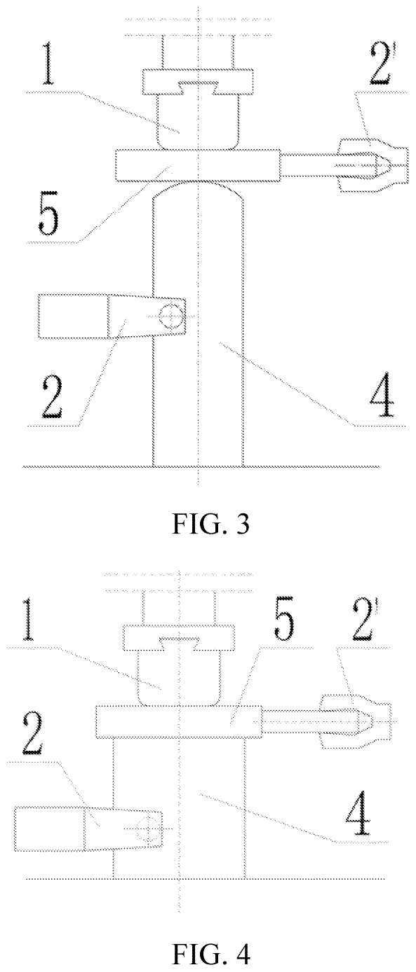

FIG. 3 is a schematic diagram in an initial state in step 3;

FIG. 4 is a schematic diagram in a final state in step 3;

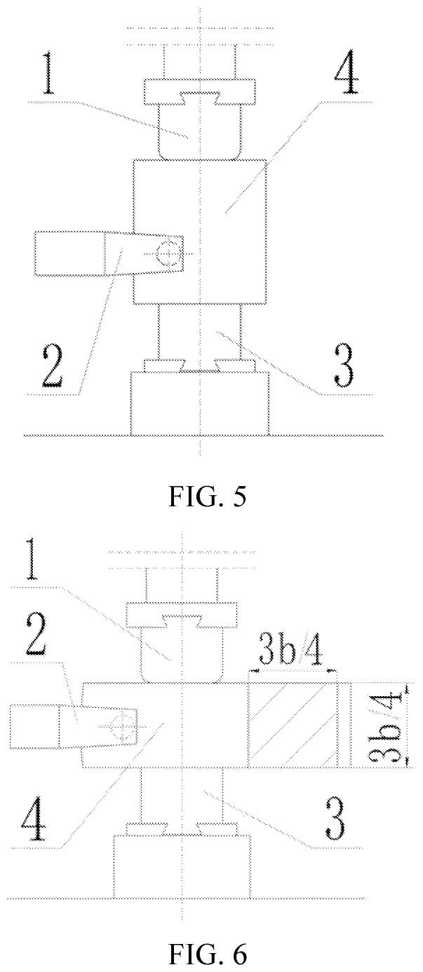

FIG. 5 is a schematic diagram in an initial state in step 4;

FIG. 6 is a schematic diagram in a final state in step 4;

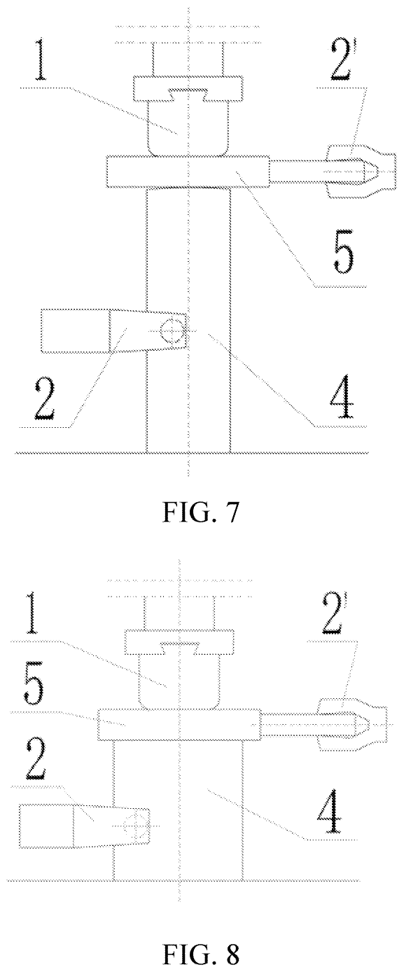

FIG. 7 is a schematic diagram in an initial state in step 5;

FIG. 8 is a schematic diagram in a final state in step 5;

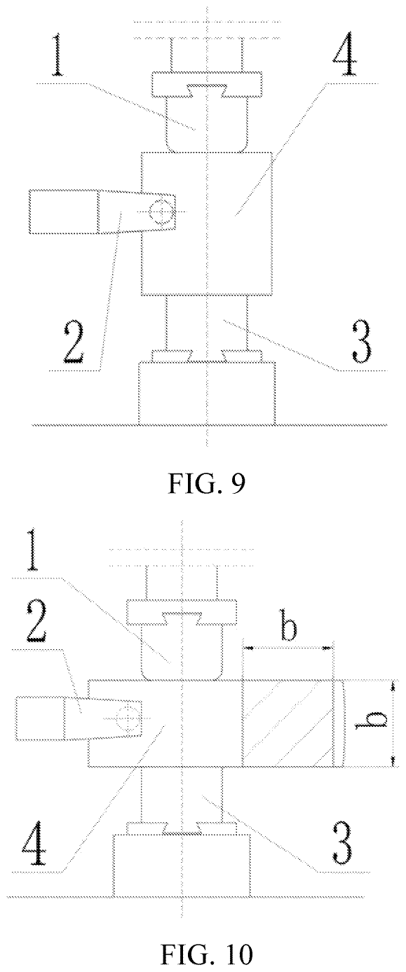

FIG. 9 is a schematic diagram in an initial state in step 6;

FIG. 10 is a schematic diagram in a final state in step 6;

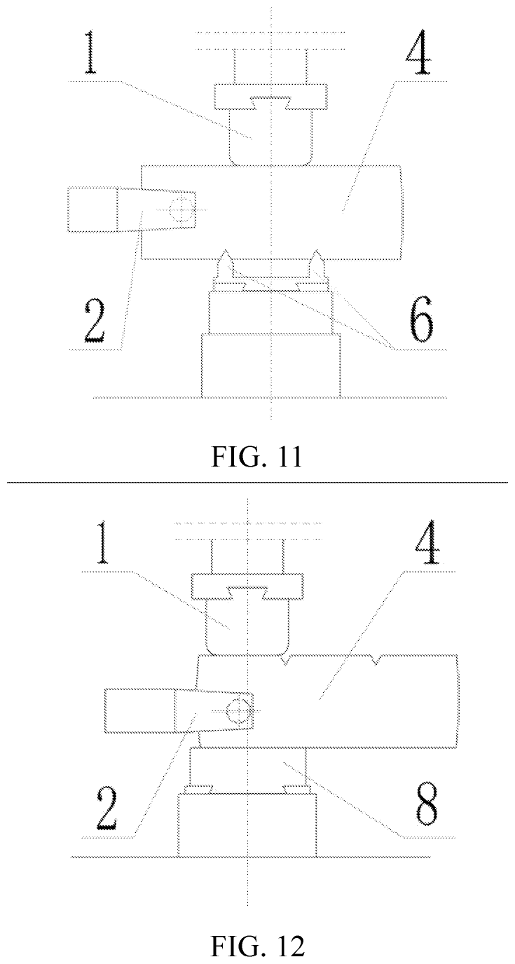

FIG. 11 is a schematic diagram in step 7;

FIG. 12 is a schematic diagram in an initial state in step 8;

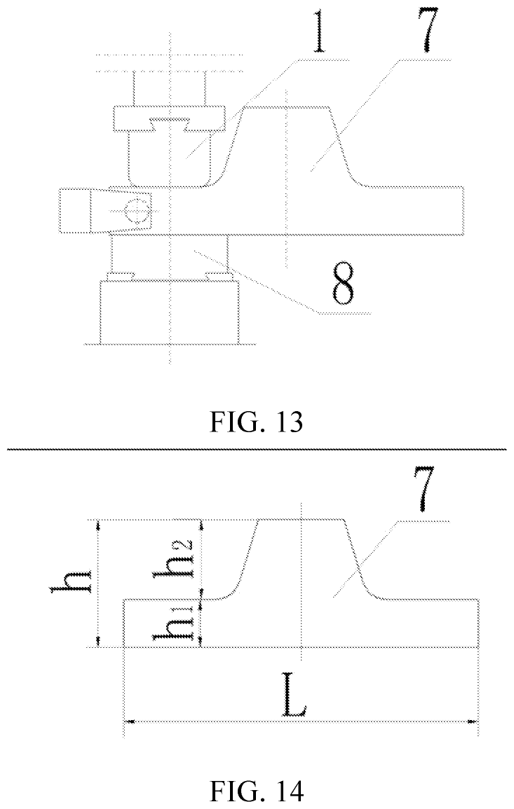

FIG. 13 is a schematic diagram in a final state in step 8;

FIG. 14 is a front view of a prefabricated part;

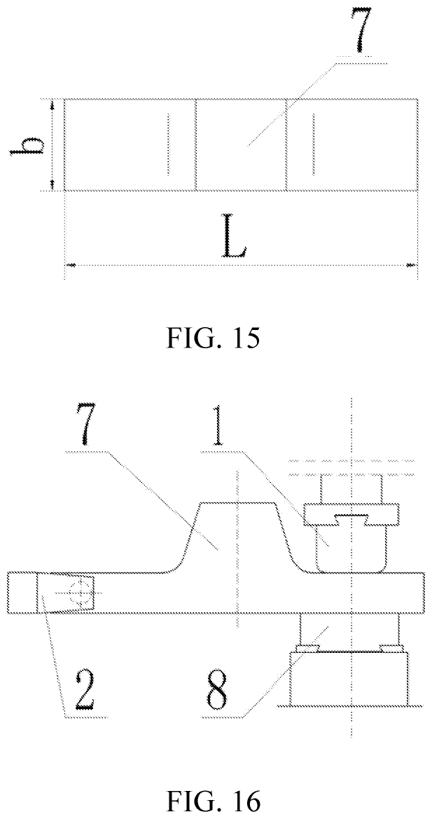

FIG. 15 is a top view of a prefabricated part;

FIG. 16 is a schematic diagram in step 10;

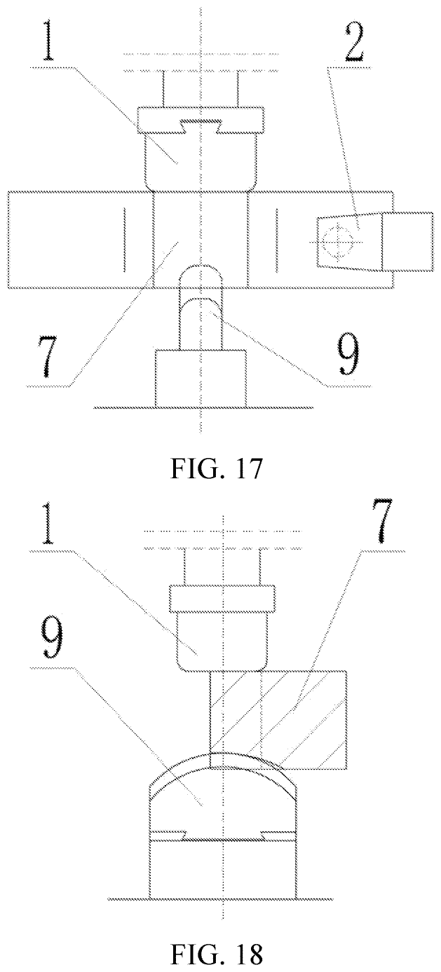

FIG. 17 is a front view in an initial forging state in step 11;

FIG. 18 is a left view of FIG. 17;

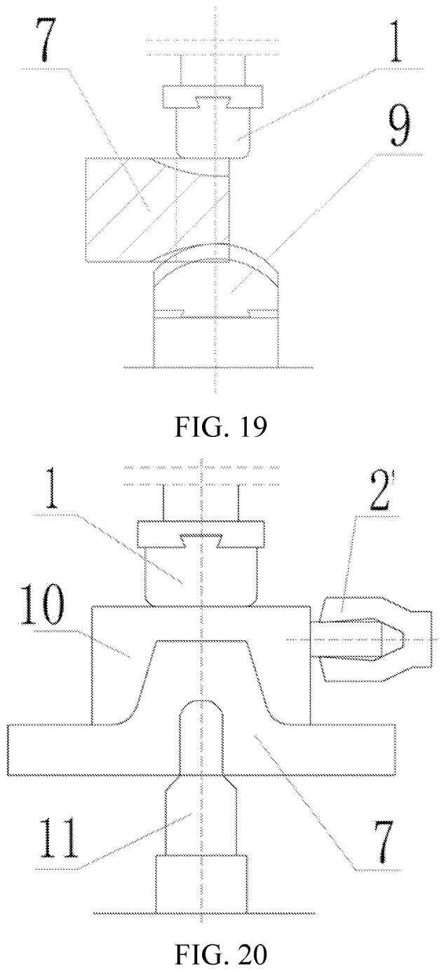

FIG. 19 is a left view of a workpiece in FIG. 17 in a state after being flipped 180°;

FIG. 20 is a schematic diagram in an initial forging state in step 12;

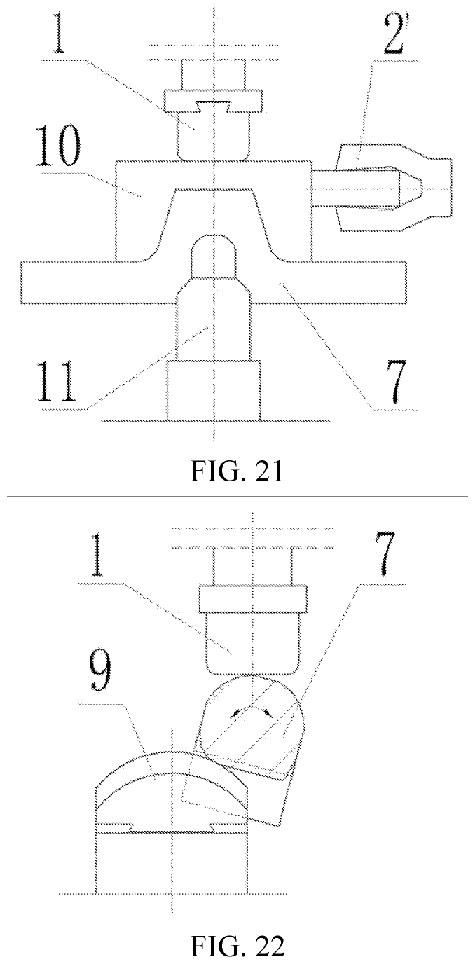

FIG. 21 is a schematic diagram in a final forging state in step 12;

FIG. 22 is a schematic diagram in a forging state in one direction in step 13;

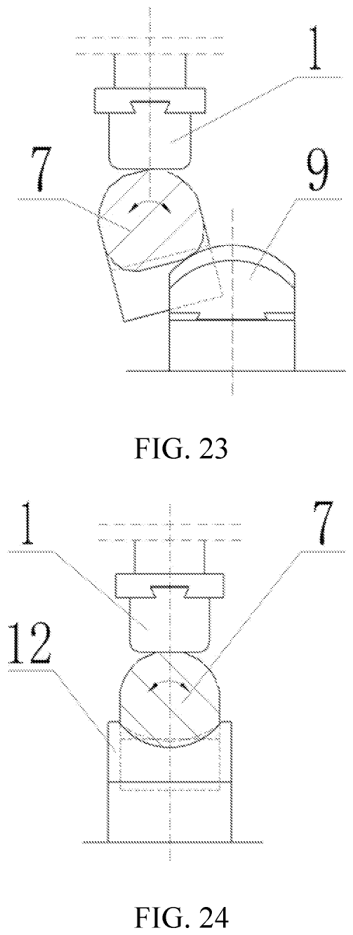

FIG. 23 is a schematic diagram in a forging state in another direction in step 13;

FIG. 24 is a schematic diagram in step 14;

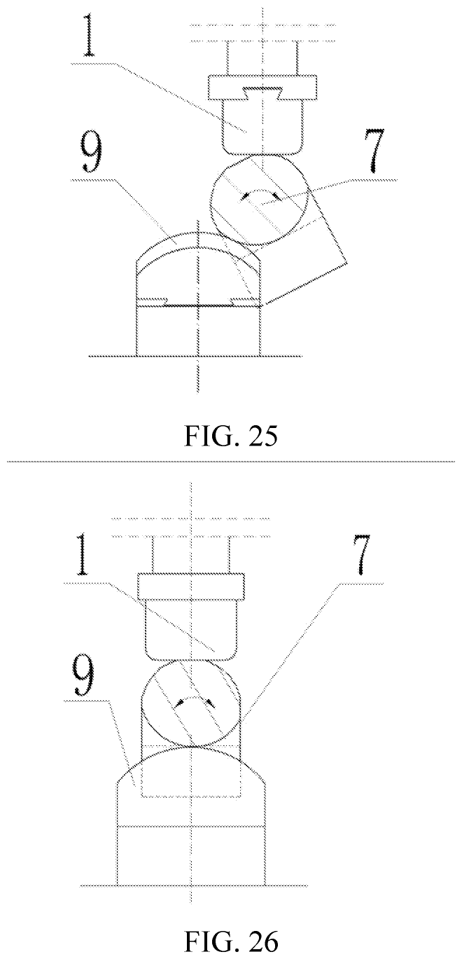

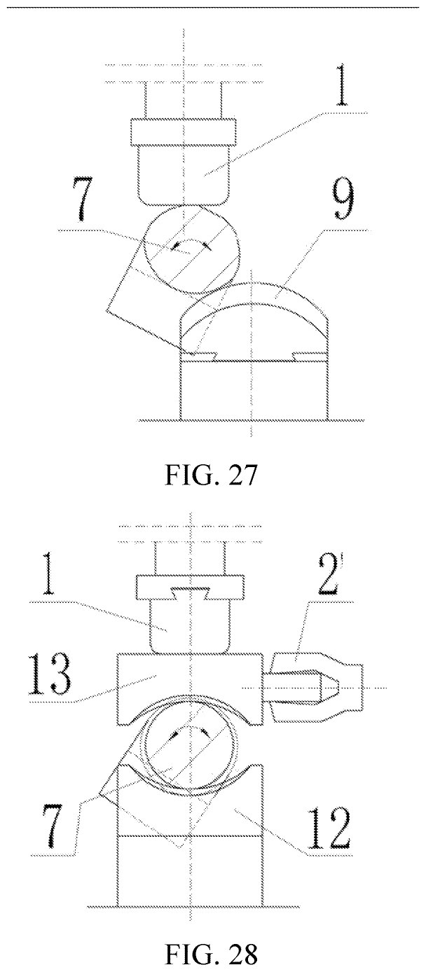

FIG. 25 to FIG. 27 are schematic diagrams in forging states through an upper anvil and a convex die in step 15;

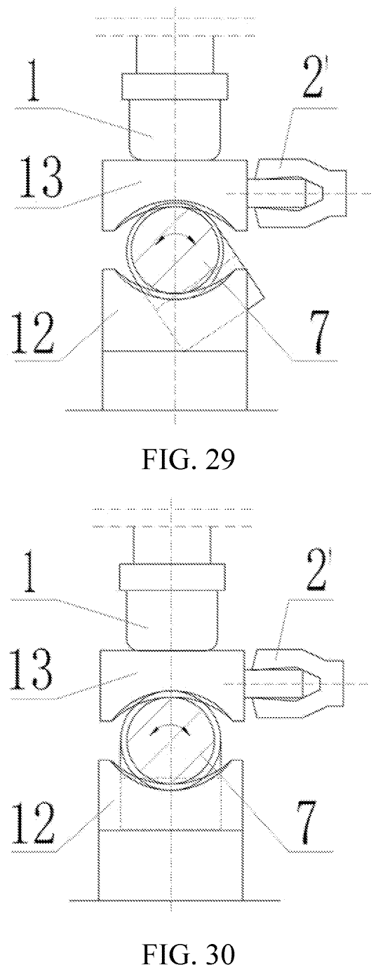

FIG. 28 to FIG. 30 are schematic diagrams in forging states through a concave replaceable anvil die and a concave die in step 15;

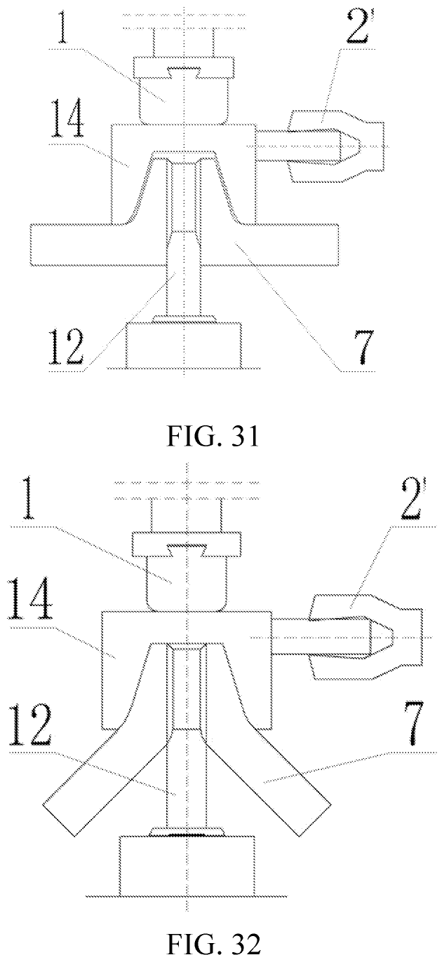

FIG. 31 is a schematic diagram in an initial forging state in step 16;

FIG. 32 is a schematic diagram in a final forging state in step 16;

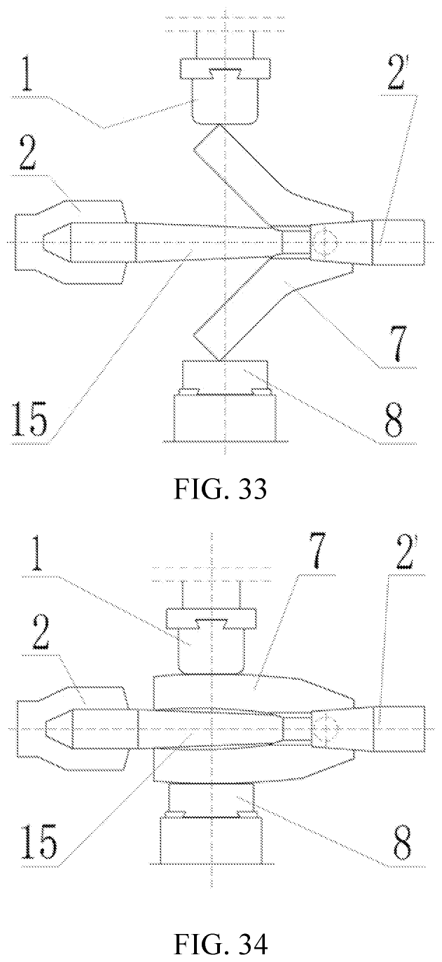

FIG. 33 is a schematic diagram in an initial forging state in step 17;

FIG. 34 is a schematic diagram in a final forging state in step 17;

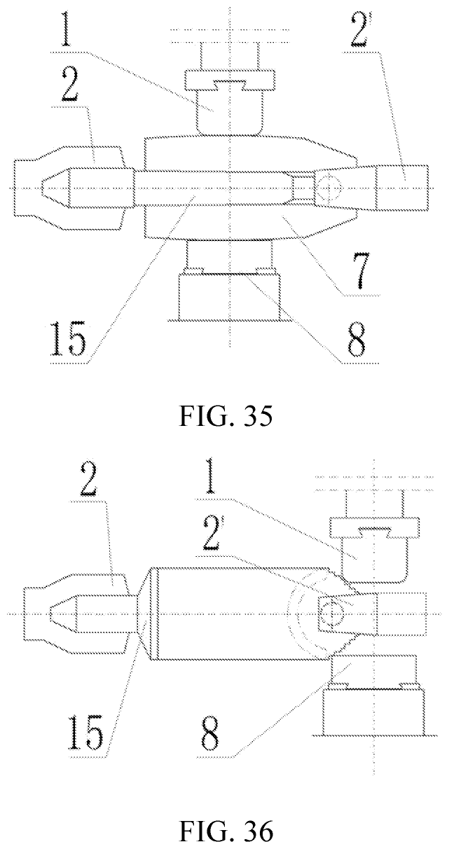

FIG. 35 is a schematic diagram in a forging state in step 18;

FIG. 36 is a schematic diagram in a forging state of a crank throw head in step 19;

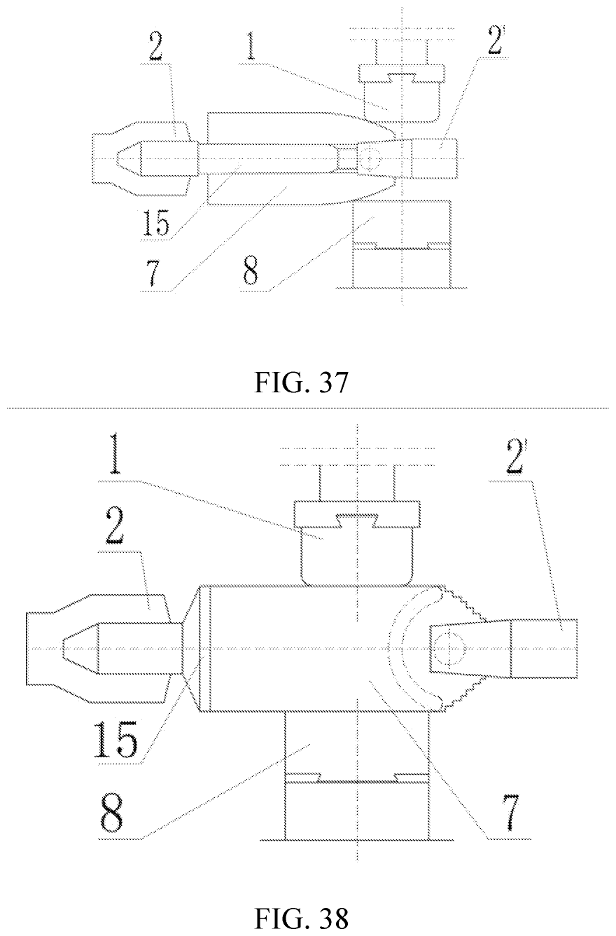

FIG. 37 is a schematic diagram in a forging state of a crank throw head by flipping a forged part in FIG. 35 90°;

FIG. 38 and FIG. 39 are schematic diagrams when finishing a crank with core dies carried in step 20; and

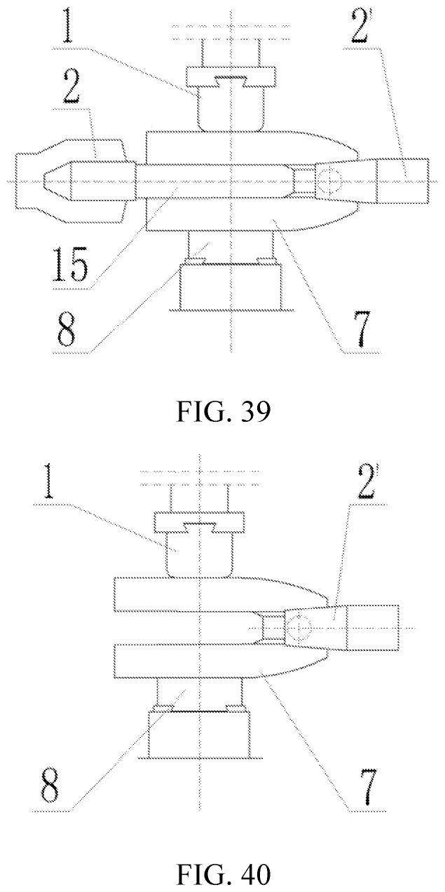

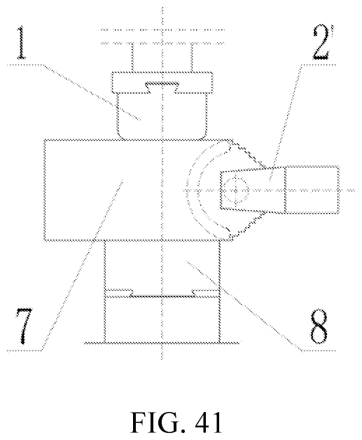

FIG. 40 and FIG. 41 are schematic diagrams when finishing a crank with core dies removed in step 20.

Description of reference numerals: 1—upper anvil, 2—first manipulator; 2′—second manipulator, 3—small flat anvil, 4—forged part; 5—upsetting plate, 6—double—ridged groove die, 7—prefabricated part, 8—large flat anvil, 9—convex die, 10—concave replaceable anvil die, 11—trapezoidal die, 12—concave die, 13—arc-shaped lower die, 14—reverse-fastening bending die, and 15—core die.

### DETAILED DESCRIPTION

The present disclosure will be further described below with reference to the drawings.

### Forging in a First Heating

Firstly, a steel billet is placed in a heating furnace and heated to a forging temperature. The steel billet may be a steel billet of 16 tons.

As shown in FIG. 1 and FIG. 2, a first manipulator 2 clamps and places the heated forged part 4 between an upper anvil 1 and a small flat anvil 3. The length and cross section of the forged part 4 are required to meet the requirement on the length-diameter ratio. Preferably, the forged part 4 is drawn out to 1.5 times an original length.

As shown in FIG. 3 and FIG. 4, a length direction of the drawn forged part 4 is stood on a longitudinal worktable, and a second manipulator 2′ clamps and places an upsetting plate 5 between the forged part and the upper anvil 1, and the forged part 4 is upset to half of an original length.

As shown in FIG. 5 and FIG. 6, the forged part 4 is placed on the small flat anvil 3 and drawn out to obtain the forged part 4 with a cross section of (3b/4)×(3b/4). Preferably, the forged part 4 is placed on the small flat anvil 3 and drawn out to obtain a forged part 4 with a cross section of 900 mm×900 mm and a length of 2500 mm.

As shown in FIG. 7 and FIG. 8, the actions in FIG. 3 and FIG. 4 are repeated to upset the forged part 4 to half of the original length. Preferably, the forged part 4 is placed on the small flat anvil 3 and the forged part 4 is upset to a length of 1250 mm.

As shown in FIG. 9 and FIG. 10, the actions in FIG. 5 and FIG. 6 are repeated to draw out to obtain a forged part 4 with a cross section of b×b. Preferably, the forged part 4 is drawn out through the upper anvil 1 and the small flat anvil 3 to obtain a forged part 4 with a cross section of 1200 mm×1200 mm and a length of 1400 mm.

As shown in FIG. 11, a middle part of the forged part 4 is placed above a double-ridged groove die 6, and parallel left and right grooves are forged below the forged part 4. Preferably, the lower anvil is replaced with a double-ridged groove die 11, and parallel left and right grooves are forged below a billet 11.

As shown in FIG. 12 and FIG. 13, the forged part 4 with the left and right grooves is flipped 180° vertically and placed on a large flat anvil 8, a left side of the left groove and a right side of the right groove are forged into a double-winged body with a width of b, a height of h1, and a length of L, and a part between the left and right grooves is forged into a boss with a height of h2 and a width of b to obtain a prefabricated part 7 of the double-winged body.

FIG. 14 and FIG. 15 are respectively a front view and a top view of the prefabricated part.

### Forging in a Second Heating

The forging in the second heating is performed on the basis of the completion of the forging of the prefabricated part in the first heating, and the shape of the prefabricated part is a double-winged body with a boss.

The prefabricated part is heated to a forging temperature.

As shown in FIG. 16, the heated prefabricated part 7 is placed on the large flat anvil 8, the upper anvil 1 presses downwards to thin and draw out double wings, and finishing to a set size is performed.

As shown in FIG. 17 to FIG. 19, the first manipulator 2 clamps the prefabricated part 7, a middle part of the prefabricated part 7 is placed above a convex die 9, and forging is performed by flipping the prefabricated part 7 180° back and forth, moving laterally and changing positions for multiple times to preliminarily forge two side surfaces of a throw journal.

As shown in FIG. 20 and FIG. 21, the boss of the prefabricated part 7 is upwards placed on a trapezoidal die 11, the second manipulator 2′ clamps and sleeves a concave anvil replaceable anvil die 10 on the prefabricated part 7, and a bottom surface of the double-winged body opposite to the boss is forged to preliminarily forge a lower surface of the throw journal.

As shown in FIG. 22 and FIG. 23, the two side surfaces and the lower surface of the throw journal are placed on the convex die 9, and the second manipulator 2′ clamps and flips the prefabricated part 7 back and forth and moves laterally to alternately forge the two side surfaces, the lower surface, and a connecting position of the throw journal until the two side surfaces, the lower surface and the connecting position of the throw journal are forged to a shape close to the shape of the throw journal. Preferably, the upper anvil 1 simultaneously forges the boss to a polygonal shape.

As shown in FIG. 24, the throw journal of the prefabricated part 7 is placed on a concave die 12, the second manipulator 2′ champs and flips the prefabricated 7 back and forth to change forging angles, and the upper anvil downwards presses a head of the boss, so that the head of the boss is forged into a polygonal upper surface of the throw journal, and the two side surfaces and the lower surface of the throw journal are forged into a semi-cylindrical body.

As shown in FIG. 25 to FIG. 30, the throw journal is placed respectively between the upper anvil 1 and the convex die 9, between the upper anvil 1 and the concave die 12, between an arc-shaped replaceable anvil die 13 and the convex die 9, and between the arc-shaped replaceable anvil die 13 and the concave die 12, and the throw journal is forged at multiple angles to obtain a cylindrical throw journal.

As shown in FIG. 31 and FIG. 32, a lower surface of the throw journal is placed on the concave die 12, the second manipulator 2′ clamps and reversely fastens a reverse-fastening bending die 14 onto the upper surface of the double wings of the double-winged body, and the upper anvil 1 presses downwards, so that the prefabricated part 7 is bent to a set angle to form a V-shape.

As shown FIG. 33 and FIG. 34, the second manipulator 2′ horizontally places the prefabricated part 7 on the large flat anvil 8, the first manipulator 2 inserts core dies 15 with the largest thickness difference between two ends into an opening of the prefabricated part 7, and the double wings are press-fit, flipped vertically and forged again, so that the double wings get close to the core dies.

A shown in FIG. 35, the first manipulator 2 sequentially replaces the core dies 15 with gradually decreasing thickness differences between two ends, the actions in FIG. 33 and FIG. 34 are repeated so that the double wings are in contact with the core dies, the prefabricated part is flipped for forging, and an outer side of the double-winged body is finished to obtain a crank of the crank throw. Preferably, two parallel cranks are forged.

As shown in FIG. 36, the core dies 15 and the prefabricated part 7 are flipped in a press-fit state, and the head of the boss is placed on the large flat anvil 8 for forging. The prefabricated part 7 in the state shown in FIG. 36 is flipped 90° to a state shown in FIG. 37, and an upper end of the throw journal is continuously forged and drawn out to obtain a quadrangular-frustum-pyramid crank throw head.

As shown in FIG. 38, the prefabricated part 7 is placed on the large flat anvil 8, and the crank is finished. Alternatively, the prefabricated part 7 is placed on the small flat anvil 3, and the crank is finished. As shown in FIG. 39, the core dies 15 and the prefabricated part 7 are flipped in a press-fit state, and a side surface of the crank is finished.

As shown in FIG. 40, the prefabricated part 7 is flipped, the crank is placed on the large flat anvil 8, and the crank throw is finished to a set size. Alternatively, the prefabricated part 7 is flipped, the crank is placed on the small flat anvil 3, and the crank throw is finished to a set size. As shown in FIG. 41, the forged part is flipped 90°, and the side surface of the crank is finished to complete the forging of the crank throw.

### INDUSTRIAL APPLICABILITY

The present disclosure relates to a two-heating forming forging process for a large crank throw, involving a forging machine, anvil dies, and an operating equipment, and including: setting a shape and parameters of a prefabricated forged part with a boss and double wings in a first heating, and performing multiple upsetting and drawing processes to complete forging of the prefabricated part; setting a shape and parameters of a multi-step transition part in a second heating, performing forging by changing angles, flipping back and forth and moving laterally, repeatedly replacing the anvil dies, performing rolling squeezing and bending by adopting a reverse-fastening bending die with an arc-shaped squeezing surface, and performing press-fitting for multiple times by adopting multiple core dies to achieve the progressive transition forming of the forged part and complete the forming forging of the crank throw. The present disclosure accomplishes forming forging and bending forging of the crank throw forged part under relatively low pressure and short forging travel, and completes the forging process for the large crank throw forged part through the forging machine with small pressure. This design has the characteristics of high forging ratio, good formability, short forging time, small material loss, and low production cost.

In addition, it can be understood that the two-heating forming forging process for a large crank throw in the present disclosure is repeatable and applicable to various industrial applications. For example, the two-heating forming forging process for a large crank throw in the present disclosure is applicable to fields such as forging.

1. A two-heating forming forging process for a large crank throw, involving a forging machine, a plurality of anvil dies, and an operating equipment, the anvil dies comprising an upper anvil, a lower die, core dies, and an upper die, the lower die comprising a small flat anvil, a large flat anvil, a double-ridged groove die, a convex die, a trapezoidal die, and a concave die, the upper die comprising an upsetting plate, a replaceable anvil die, and a reverse-fastening bending die; the operating equipment comprising a worktable and a manipulator, the worktable comprising a transverse worktable and a longitudinal worktable, the manipulator comprising a first manipulator and a second manipulator; the upper anvil being connected to the forging machine, the convex die and the double-ridged groove die respectively forming a fixed hinge with the large flat anvil, the replaceable anvil die comprising a concave replaceable anvil die and an arc-shaped replaceable anvil die, a plurality of core dies being provided, thickness differences between two ends of different core dies being different, the lower die being placed on the transverse worktable and moving with the transverse worktable, the first manipulator clamping a forged part, the second manipulator clamping the core dies or the upper die,
the two-heating forming forging process for a large crank throw comprising:
a first heating: forging a prefabricated part of a double-winged body with a boss in a middle part, setting the double-winged body to have a length of L, a width of b, and a height of h₁; and
setting the boss to have a height of h₂ and a width of b, then the total height of the prefabricated part being h=h₁+h₂, comprising:
step I: selecting a steel billet according to a weight requirement of the crank throw forged part, and heating the steel billet to a set forging temperature;
step II: placing the steel billet heated in step I between the upper anvil and the small flat anvil, and drawing out the steel billet;
step III: standing a length direction of the forged part drawn out in step II on the longitudinal worktable, clamping and placing the upsetting plate between the forged part and the upper anvil through the second manipulator, and upsetting the forged part to ½ of an original length;
step IV: drawing out the forged part upset in step III to obtain a forged part with a cross section of (3b/4)×(3b/4);
step V: standing a length direction of the forged part drawn out in step IV on the longitudinal worktable, and upsetting the forged part to ½ of the original length;
step VI: drawing out the forged part upset in step V to obtain a forged part with a cross section of b×b;
step VII: placing a middle part of the forged part drawn out in step VI above the double-ridged groove die, and forging parallel left and right grooves below the forged part; and
step VIII: vertically flipping the forged part with the left and right grooves obtained in step VII 180°, placing the forged part on the large flat anvil for forging, correspondingly forging a left side of the left groove and a right side of the right groove into a double-winged body with a width of b, a height of h1, and a length of L, and forging a part between the left and right grooves into a boss with a height of h2 and a width of b to obtain the prefabricated part of the double-winged body; and
a second heating: forging forming, setting transition shapes and parameters of double wings and a throw journal, and setting bending parameters, comprising:
step IX: heating the prefabricated part obtained in step VIII to a forging temperature;
step X: placing the heated prefabricated part on the large flat anvil, thinning and drawing out the double wings, and performing finishing to a set size;
step XI: clamping the prefabricated part through the first manipulator, placing a middle part of the prefabricated part obtained in step X above the convex die, and performing forging by flipping 180° back and forth, moving laterally and changing positions for a plurality of times to preliminarily forge two side surfaces of the throw journal;
step XII: placing the boss of the prefabricated part obtained in step XI upwards on the trapezoidal die, clamping and sleeving the concave anvil replaceable anvil die on the prefabricated part through the second manipulator, and forging a bottom surface of the double-winged body opposite to the boss to preliminarily forge a lower surface of the throw journal;
step XIII: placing the two side surfaces and the lower surface of the throw journal obtained in step XI and step XII on the convex die, and alternately forging the two side surfaces, the lower surface, and a connecting position of the throw journal by flipping back and forth and moving laterally until a shape is close to the shape of the throw journal;
step XIV: placing the throw journal of the prefabricated part obtained in step XIII on the concave die, changing forging angles by flipping back and forth, and downwards pressing a head of the boss through the upper anvil, so that the head of the boss is forged into a polygonal upper surface of the throw journal, and the two side surfaces and the lower surface of the throw journal are forged into a semi-cylindrical body;
step XV: placing the throw journal forged in step XIV alternately on the convex die and the concave die, and forging the throw journal at a plurality of angles through the upper anvil by respectively adopting a non-flat anvil and the arc-shaped replaceable anvil die to obtain a cylindrical billet of the throw journal;
step XVI: placing a lower surface of the cylindrical throw journal on the concave die, and clamping and reversely fastening the reverse-fastening bending die onto the upper surface of the double wings of the double-winged body through the second manipulator, so that the prefabricated part is bent to a set angle to form a V-shape;
step XVII: placing the V-shaped prefabricated part on the large flat anvil, inserting the core dies with the largest thickness difference between two ends into an opening of the prefabricated part through the second manipulator, press-fitting two sides of the V-shape so that the two sides of the prefabricated part get close to each other, and performing forging again by flipping vertically so that the two sides of the prefabricated part get close to the core dies;
step XVIII: sequentially replacing the core dies with gradually decreasing thickness differences between two ends, repeating step XVII so that the double wings of the double-winged body are in contact with the core dies, flipping the prefabricated part for forging, and finishing an outer side of the double-winged body to obtain a crank of the crank throw;
step XIX: synchronously flipping the core dies and the prefabricated part in a press-fit state, forging the head of the boss, and drawing the head into a quadrangular-frustum-pyramid crank throw head; and
step XX: placing the prefabricated part obtained in step XIX on the large flat anvil or the small flat anvil, and finishing the crank throw to a set size.

2. The two-heating forming forging process for a large crank throw according to claim 1, wherein the first manipulator is a left manipulator and the second manipulator is a right manipulator.

3. The two-heating forming forging process for a large crank throw according to claim 1, wherein in step II, the steel billet is drawn out to 1.2 to 1.7 times the original length.

4. The two-heating forming forging process for a large crank throw according to claim 1, wherein in step III, the rectangular forged part is upset to ½±20% of the original length.

5. The two-heating forming forging process for a large crank throw according to claim 1, wherein in step IV, the forged part is drawn out to obtain a rectangular billet with a cross section of 3b/4 (1±5%)×3b/4 (1±5%).

6. The forging process for a crank throw prefabricated part according to claim 1, wherein in step V, the forged part is upset to ½±10% of the original length.

7. The forging process for a crank throw prefabricated part according to claim 1, wherein in step VI, the forged part is upset to obtain a forged part with a cross section of b(1+0-5%)×b(1+0-5%).

8. The two-heating forming forging process for a large crank throw according to claim 1, wherein the convex die is an arc-shaped die.

9. The two-heating forming forging process for a large crank throw according to claim 1, wherein the diameter of the prefabricated part of the throw journal in a vertical direction is equal to the diameter of a finished product ±5%.

10. The two-heating forming forging process for a large crank throw according to claim 1, wherein a concave surface of the concave replaceable anvil die is engaged with a convex surface of the prefabricated part.
